(19) United States
(12) Patent Application Publication
(10) Pub. No.: US 2023/0020454 A1
(43) Pub. Date: Jan. 19, 2023

(54) MIXED REALITY (MR) PROVIDING DEVICE FOR PROVIDING IMMERSIVE MR, AND CONTROL METHOD THEREOF

(71) Applicant: SAMSUNG ELECTRONICS CO., LTD., Suwon-si (KR)

(72) Inventor: Oleksandr SHCHUR, Kyiv (UA)

(21) Appl. No.: 17/952,102

(22) Filed: Sep. 23, 2022

Related U.S. Application Data
(63) Continuation of application No. PCT/KR2021/013689, filed on Oct. 6, 2021.

(30) Foreign Application Priority Data
Oct. 6, 2020 (KR) 10-2020-0128589

(51) Int. Cl. G06T 11/00; G06V 20/20; G06V 10/22; G06T 7/55; G06V 10/764; G06T 7/70

(52) U.S. Cl. CPC G06T 11/00; G06V 20/20; G06V 10/22; G06T 7/55; G06V 10/764; G06T 7/70; G06T 2207/20081; G06T 2207/30242; G06T 2207/20084; G06T 2207/10016

(57) ABSTRACT

A mixed reality (MR) providing device is disclosed. The MR providing device includes: a camera, a communication unit comprising circuitry configured to communicate with an electronic device providing video, an optical display unit comprising a display configured to simultaneously display real space within a preset range of viewing angle and a virtual image, and a processor. The processor is configured to: capture the preset range of viewing angle through the camera to acquire an image, identify at least one semantic anchor spot of the acquired image in which an object may be positioned, transmit characteristic information of the semantic anchor spot related to the object that may be positioned to the electronic device through the communication unit, receive an object region including the object corresponding to the characteristic information and included in an image frame of the video from the electronic device through the communication unit, and control the optical display unit to display the received object region on the semantic anchor spot.

### CROSS-REFERENCE TO RELATED APPLICATIONS

This application is a bypass continuation of International Application No. PCT/KR2021/013689, filed on Oct. 6, 2021, which is based on and claims priority to Korean Patent Application No. 10-2020-0128589, filed on Oct. 6, 2020, in the Korean Intellectual Property Office, the disclosures of which are incorporated by reference herein in their entireties.

### BACKGROUND

### Field

The disclosure relates to a mixed reality (MR) providing device, and for example, to an MR providing device for providing a real physical space and video content together.

### Description of the Related Art

MR is a concept providing a mixture of real and virtual images and refers to a technology that visually provides an environment in which real physical objects and virtual objects interact with each other. MR is also a concept often used interchangeably with augmented reality (AR).

AR/MR providing devices, which are emerging as strong candidates to replace smartphones in the future, have mainly been developed in the form of head mounted devices (HMDs) or wearable glasses.

In addition, various types of optical display units for displaying real space and virtual information together have already been developed.

For example, various AR/MR optical technologies for displaying a virtual image to a desired position/depth within a user's viewing angle, such as a technology of splitting light from a mini-projector and inputting split light into a plurality of optical waveguides (e.g., magic leap one), a technology using a holographic method (e.g., hololense), a technology of using a pin mirror method in which small reflective pinholes are disposed on a lens (e.g., PinMR of LetinAR), have been provided.

Meanwhile, it is also possible to provide a composite image obtained by synthesizing a virtual image with a real image captured by a camera through a general display. Since this method does not require the optical display unit described above, it may be implemented with a general smartphone or tablet PC currently in use (e.g., Pokemon Go).

Based on the technologies mentioned above, it is possible to sufficiently provide virtual video content in real space, such as providing a virtual TV screen on a wall of a living room.

However, in the case of providing virtual video content using the MR providing device, image quality thereof is very low, compared with a real TV, due to limitations of a size/weight/operation speed of the MR providing device generally provided as an HMD or wearable glasses.

Also, even if image quality can be realized at the same level as that of a real TV, it may be difficult to consider that a method in which the MR providing device provides a 2D image through a virtual TV screen placed on a wall provides a more immersive user experience than a method of providing video content through an real TV without the MR providing device.

### SUMMARY

Embodiments of the disclosure provide a mixed reality (MR) providing device for appropriately merging video content received from an external electronic device in a real environment and providing the same.

Embodiments of the disclosure provide an MR providing device in which an external electronic device identifies a real position in which an object included in video content may be positioned, and provides the corresponding object to a user as a virtual image on the identified position.

According to an example embodiment of the disclosure, a mixed reality (MR) providing device includes: a camera, a communication unit comprising communication circuitry configured to communicate with an electronic device providing video, an optical display unit comprising a display configured to simultaneously display real space within a preset range of viewing angle and a virtual image, and a processor. The processor may be configured to: acquire an image by capturing the preset range of viewing angle through the camera, identify at least one semantic anchor spot of the acquired image in which an object may be positioned, control the communication unit to transmit characteristic information of the semantic anchor spot related to the object that may be positioned to the electronic device, control the communication unit to receive an object region including the object corresponding to the characteristic information among at least one object included in an image frame of the video from the electronic device, and control the optical display unit to display the received object region on the semantic anchor spot.

According to an example embodiment of the disclosure, an electronic device includes: a memory configured to store a video, a communication unit comprising communication circuitry configured to communicate with a mixed reality (MR) providing device, and a processor connected to the memory and the communication unit. The processor may be configured to: control the communication unit to receive characteristic information of a semantic anchor spot included in an image acquired through the MR providing device from the MR providing device, identify an object corresponding to the received characteristic information in an image frame included in the video, and control the communication unit to transmit an object region including the identified object to the MR providing device.

According to an example embodiment of the disclosure, a method of controlling a mixed reality (MR) providing device for providing real space within a preset range of viewing angle and a virtual image includes: acquiring an image by capturing the preset range of viewing angle through a camera, identifying at least one semantic anchor spot within the acquired image in which an object may be positioned, transmitting characteristic information of the semantic anchor spot related to the object that may be positioned to an electronic device, receiving an object region including the object corresponding to the characteristic information among at least one object included in an image frame of the video provided from the electronic device, and displaying the received object region on the semantic anchor spot.

According to an example embodiment of the disclosure, a mixed reality (MR) providing device includes: a camera, a communication unit comprising communication circuitry configured to communicate with an electronic device providing a video, a display, and a processor. The processor is configured to: identify at least one semantic anchor spot in an image acquired through the camera in which an object may be positioned, control the communication unit to transmit characteristic information of the semantic anchor spot related to the object that may be positioned to the electronic device, control the communication unit to receive an object region including the object corresponding to the characteristic information among at least one object included in an image frame of the video from the electronic device, synthesize the received object region on the semantic anchor spot included in the acquired image to acquire an MR image, and control the display to display the acquired MR image.

According to various example embodiments of the disclosure, since the MR providing device provides an object in video content in real space, there is an effect of providing more immersive MR video content.

With the MR provided by the MR providing device, a user may be simultaneously provided with performance of objects within video content, while performing real work (e.g., cooking, eating, etc.) using objects in real space (e.g., cooking tools, tableware, etc.). For example, the user does not need to turn to a virtual TV screen to view video content while cooking.

Since the MR providing device according to various embodiments of the disclosure receives a semantically identified object region within video content, and not the entire video content, from an external electronic device, immersive MR may be provided, while streaming data capacity of video content is reduced.

### BRIEF DESCRIPTION OF THE DRAWINGS

FIG. 1 is a diagram illustrating an example operation of a mixed reality (MR) providing device according to various embodiments;

FIG. 2 is a block diagram illustrating an example configuration and operation of each of the MR providing device and an electronic device according to various embodiments;

FIGS. 3A, 3B and 3C are diagrams illustrating an example operation of an MR providing device to identify a semantic anchor spot based on a width and height of a horizontal plane according to various embodiments;

FIG. 4A is a diagram illustrating an example operation of an MR providing device to identify a semantic anchor spot using an artificial intelligence model according to various embodiments;

FIGS. 4B and 4C are diagrams illustrating an example of a learning process of an artificial intelligence model used in FIG. 4A according to various embodiments;

FIG. 5A is a diagram illustrating an example operation of predicting an object that may be positioned at a semantic anchor spot using the number of existing objects by the type by an MR providing device according to various embodiments;

FIG. 5B is a diagram illustrating an example of generating training data for training an artificial intelligence model used in FIG. 5A according to various embodiments;

FIG. 5C is a block diagram illustrating an example in which an MR providing device trains the artificial intelligence model of FIG. 5A using the training data acquired in FIG. 5B and predicts an object using the trained artificial intelligence model according to various embodiments;

FIG. 6A is a diagram illustrating an operation of an electronic device recognizing an object in a video based on characteristic information according to an embodiment of the present disclosure;

FIG. 6B is a diagram illustrating an example operation of an electronic device recognizing an object in a video based on characteristic information (a predicted object list) according to various embodiments;

FIG. 7 is a diagram illustrating an example operation in which an MR providing device determines a position of an object region to be displayed within the user's field of view according to various embodiments;

FIG. 8 is a diagram illustrating an example operation in which an MR providing device determines the positions of object regions using a distance between the MR providing device and a semantic anchor spot and the positional relationship between the object regions according to various embodiments;

FIG. 9A is a diagram illustrating an example operation of recognizing semantic anchor spots and objects existing in each of the semantic anchor spots by an MR providing device according to various embodiments;

FIG. 9B is a diagram illustrating an example operation of positioning an object region on a selected semantic anchor spot by an MR providing device according to various embodiments;

FIG. 10 is a diagram illustrating an example operation in which an MR providing device determines a position of an object region using a GAN model according to various embodiments;

FIG. 11A is a diagram illustrating an example of generating training data of the GAN model used to determine a position of an object region according to various embodiments;

FIG. 11B is a diagram illustrating an example of training data of a GAN model according to various embodiments;

FIG. 12 is a block diagram illustrating an example configuration of an MR providing device according to various embodiments;

FIG. 13 is a block diagram illustrating an example configuration and operation of an MR providing device for providing MR using a display according to various embodiments;

FIG. 14 is a flowchart illustrating an example method of controlling an MR providing device according to various embodiments; and

FIG. 15 is a flowchart illustrating an example algorithm of an MR providing device and a method of controlling an electronic device according to various embodiments.

### DETAILED DESCRIPTION

Before describing the present disclosure in detail, a method of describing the present disclosure and drawings will be described.

The terms used in this disclosure and claims are selected to include general terms in consideration of functions in various example embodiments. However, these terms may vary according to intentions of persons skilled in the art or legal or technical interpretations and appearance of new technologies. In certain cases, a term may be one that was arbitrarily selected. Such terms may be interpreted as having meanings defined in this disclosure, and if a term is not specifically defined, it may be interpreted on the basis of general contents of this disclosure and general technical common sense in the art.

Throughout the disclosure, the like reference numerals denote substantially the same elements. For the purposes of description and understanding, the same reference numerals or symbols will be used in different example embodiments and described. That is, although all the components are illustrated with the same reference numerals in a plurality of drawings, the plurality of drawings do not signify a single example embodiment.

In this disclosure and claims, the ordinal terms first, second, etc. may be used to distinguish elements from each other. These ordinal terms are simply used to distinguish the same or similar elements from another, and meanings of terms should not be limited in interpretation due to the use of the ordinal terms. For example, elements combined with such ordinal terms should not be limited in usage order or disposition order by the number. If necessary, each ordinal numbers may be replaced to be used.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the disclosure, and are not intended to preclude the possibility that one or more other features, numbers, operations, actions, components, parts, or combinations thereof may exist or may be added.

The terms “unit”, “part” and “module” described in the disclosure may refer, for example, to components for processing at least one function and operation and can be implemented by hardware components or software components and combinations thereof. Also, a plurality of “modules”, “units”, and “parts” may be integrated into at least a single module or chip and implemented as at least one processor, except for a case in which each of them needs to be implemented as specific individual hardware.

It will be understood that when an element is referred to as being “connected to” another element, it can be directly connected to the other element or intervening elements may also be present. In addition, unless explicitly described to the contrary, the word “comprise” and variations such as “comprises” or “comprising,” will be understood to imply the inclusion of stated elements but not the exclusion of any other elements.

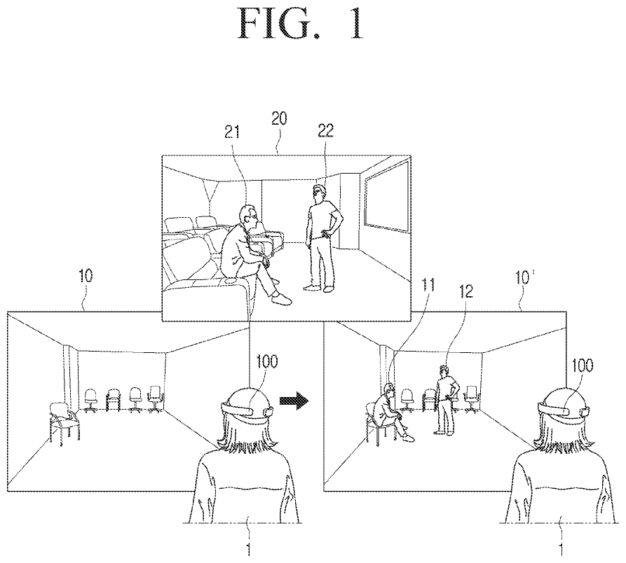

FIG. 1 is a diagram illustrating an example operation of a mixed reality (MR) providing device according to various embodiments.

Referring to FIG. 1, when a user 1 wears an MR providing device 100 (or an MR apparatus 100) implemented, for example, as a head-mounted display (HMD), the MR providing device 100 may provide an image 10 of real space to the user 1.

The MR providing device 100 may communicate with at least one external electronic device that provides a video 20 including a plurality of image frames.

The video 20 may correspond to various contents. For example, the video 20 may correspond to news, talk shows, concerts, sports, e-sports, movies, etc. The video 20 may be a live broadcast provided in real time or a real-time image containing a counterpart of a video call.

In this case, the MR providing device 100 may receive only a partial object region included in the video 20 for each image frame in real time, without streaming the entire video 20.

Referring to FIG. 1, the MR providing device 100 may receive object regions 11 and 12 respectively including persons 21 and 22 included in the image frame, rather than the entire image frame of the video 20.

The MR providing device 100 may provide the object regions 11 and 12 respectively as virtual images on a chair and a specific empty space in real space.

As a result, the user 1 may feel as if the persons 21 and 22 in the video 20 are together in the real space 10′.

Hereinafter, an example configuration and operation of the MR providing device 100 will be described in greater detail with reference to the drawings.

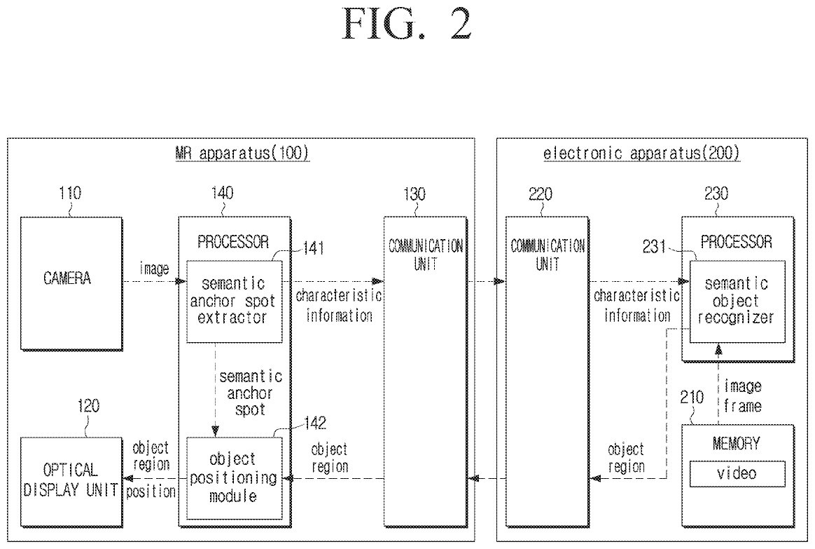

FIG. 2 is a block diagram illustrating an example configuration and operation of each of an MR providing device and an electronic device according to various embodiments.

Referring to FIG. 2, the MR providing device 100 may include a camera 110, an optical display unit (e.g., including a display) 120, a communication unit (e.g., including communication circuitry) 130, a processor (e.g., including processing circuitry) 140, and the like.

The MR providing device 100 may be implemented in various forms, such as an HMD and AR/MR glasses. In addition, according to the development of technology, the MR providing device 100 may be implemented as a smart lens capable of communicating with at least one computing device.

The camera 110 is a component for imaging real space and may include at least one of a depth camera and an RGB camera.

The depth camera may acquire depth information (a depth image or a depth map) indicating a distance between each point in the real space and the depth camera. To this end, the depth camera may include at least one ToF sensor.

An RGB camera may acquire an RGB image. To this end, the RGB camera may include at least one optical sensor terminal.

The camera 110 may include two or more RGB cameras (e.g., stereo cameras). In this case, depth information may be acquired based on a difference in positions of pixels corresponding to each other in images captured by the RGB cameras.

The optical display unit 120 may include a display and is configured to simultaneously display a virtual image provided through the processor 140 and real space within a range of a viewing angle viewed by the user.

The range of the viewing angle in which the optical display unit 120 provides real space may be preset according to an installation structure of the optical display unit 120 in the MR providing device 100.

The range of the viewing angle may be based on a forward direction (a user's gaze direction) of the MR providing device 100.

The processor 140 may include various processing circuitry and image a preset range of viewing angle through the camera 110, and the range of the viewing angle imaged by the camera 110 may also be based on the forward direction of the MR providing device 100, like a reference angle of the range of the viewing angle provided by the optical display unit 120.

The optical display unit 120 may provide a virtual image through various methods such as a method of splitting light and inputting split light into a plurality of optical waveguides, a holographic method, a pin mirror method, and the like. To this end, the optical display unit 120 may include various components such as a projector, a lens, a display, and a mirror.

The processor 140 may control the display to display, through the optical display unit 120, a virtual image or virtual information of various depths in various positions within a range of a viewing angle (real space) provided to the user.

Through the communication unit 130, the processor 140 may communicate with an external electronic device 200 (or an electronic apparatus).

Referring to FIG. 2, the processor 140 of the MR providing device 100 may include a semantic anchor spot extractor (e.g., including various processing circuitry and/or executable program instructions) 141 (hereinafter, referred to as an extractor), an object positioning module (e.g., including various processing circuitry and/or executable program instructions) 142, and the like.

The electronic device 200 may include a device capable of storing/providing at least one video. The electronic device 200 may be implemented as various devices such as a TV, a set-top box, and a server, but is not limited thereto.

Referring to FIG. 2, the electronic device 200 may include a memory 210, a communication unit (e.g., including communication circuitry) 220, a processor (e.g., including processing circuitry) 230, and the like.

The memory 210 may include a video including a plurality of image frames.

The processor 230 of the electronic device 200 may include various processing circuitry and communicate with the MR providing device 100 through the communication unit 220.

The processor 230 may include a semantic object recognizer (e.g., including various processing circuitry and/or executable program instructions) 231.

The modules 141, 142, and 231 described above may be implemented in software or hardware, respectively, and may be implemented as a combination of software and hardware.

The processor 140 of the MR providing device 100 according to an embodiment of the present disclosure may acquire an image of real space by imaging a preset range of a viewing angle through the camera 110.

The extractor 141 may include various processing circuitry and/or executable program instructions for identifying semantic anchor spots existing in real space. The extractor 141 may identify at least one semantic anchor spot in an image obtained by imaging real space through the camera 110.

The semantic anchor spot may include a spot in which at least one object may be positioned.

For example, a semantic anchor spot may be various horizontal planes present in real space such as a floor surface on which a person standing may be present, a chair surface on which a seated person may be present, a table surface on which dishes may be placed, and a desk surface on which office supplies may be placed.

However, the semantic anchor spot does not necessarily correspond to the horizontal plane, and, for example, in the case of a hanger in real space, the hanger may be a semantic anchor spot in which the clothes may be positioned.

In addition, the extractor 141 may also acquire characteristic information of the semantic anchor spot defined together with the semantic anchor spot.

The characteristic information of the semantic anchor spot may include information on an object that may be positioned at the semantic anchor spot.

For example, the characteristic information of the semantic anchor spot may include information on a type of object that may be positioned in the semantic anchor spot.

The type of object may include not only a moving object such as a person, a dog, a character (e.g., a monster), but also a non-moving object or plant such as a cup, a book, a TV, or a tree. In addition, the type of object may be further subdivided into a person standing, a person sitting, a person running, a person walking, a person lying, a large dog, a small dog, and the like.

In addition, the type of object that may be positioned at the semantic anchor spot may be further subdivided into a part (arm, leg, leaf) of each of the objects (person, tree) described above.

According to an embodiment, the characteristic information of the semantic anchor spot may include at least one vector quantifying the possibility that an object exists at the semantic anchor spot for each type of object.

The characteristic information of the semantic anchor spot may also include information on a size, shape, number, etc. of objects that may be positioned at the semantic anchor spot.

According to an embodiment, the extractor 141 may identify a horizontal plane within the (depth) image captured by the camera 110 and determine whether the corresponding horizontal plane is a semantic anchor spot using a horizontal width and vertical height of the identified horizontal plane.

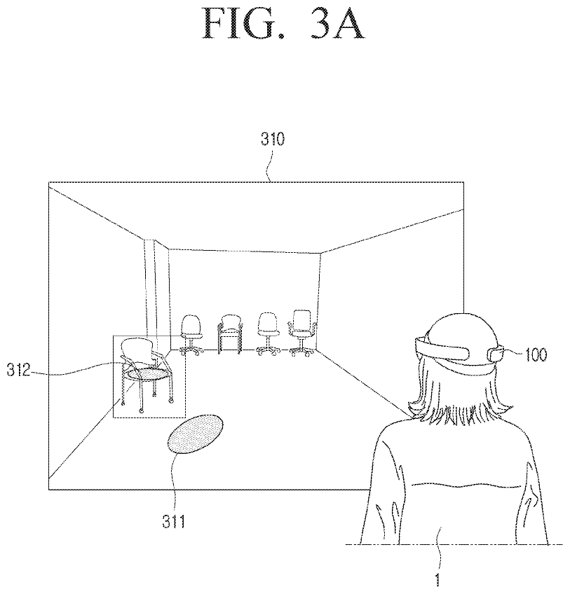

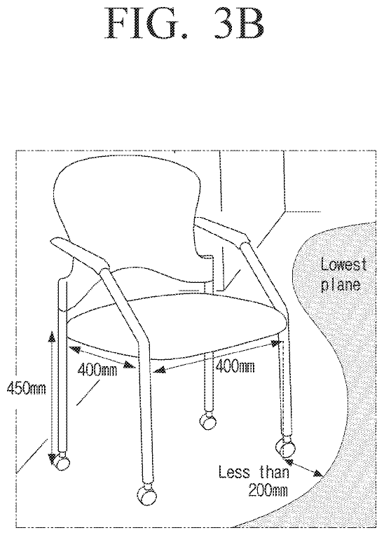

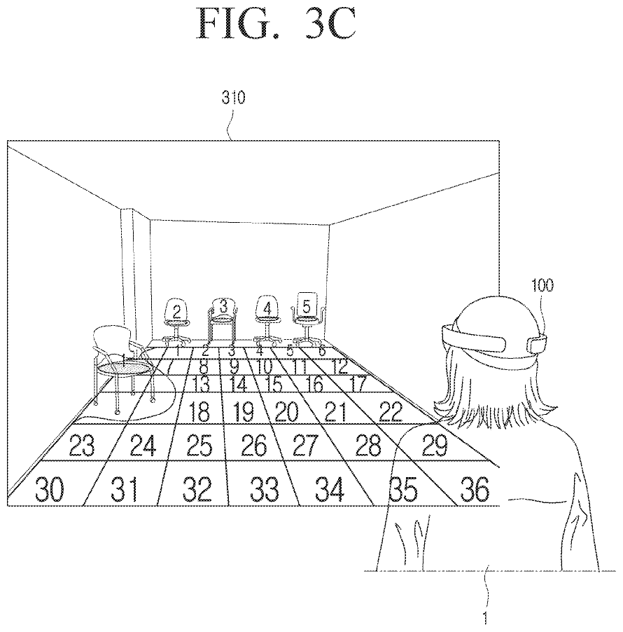

For example, in relation to the horizontal width of the horizontal plane, when the horizontal length is 40 mm or more and the vertical length is 40 mm or more, the extractor 141 may identify the horizontal plane as a semantic anchor spot where a ‘person standing’ may be positioned. The ‘person standing’ may include characteristic information of the semantic anchor spot. A related embodiment is described in greater detail below with reference to FIGS. 3A and 3B.

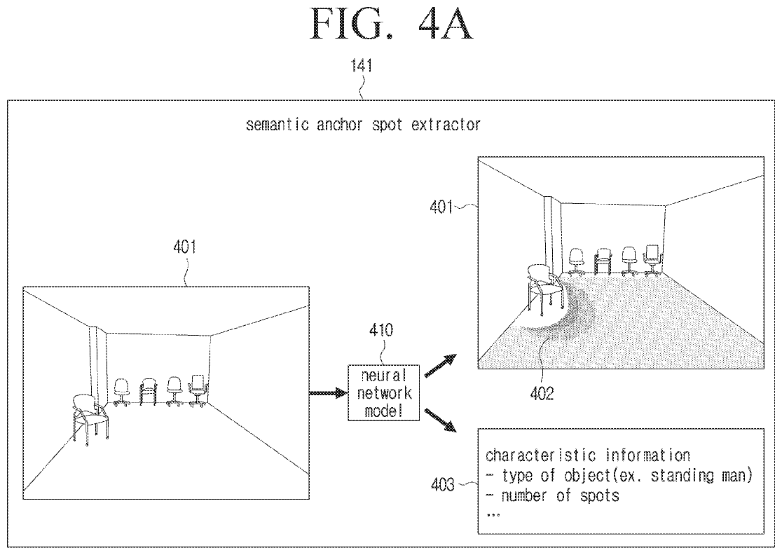

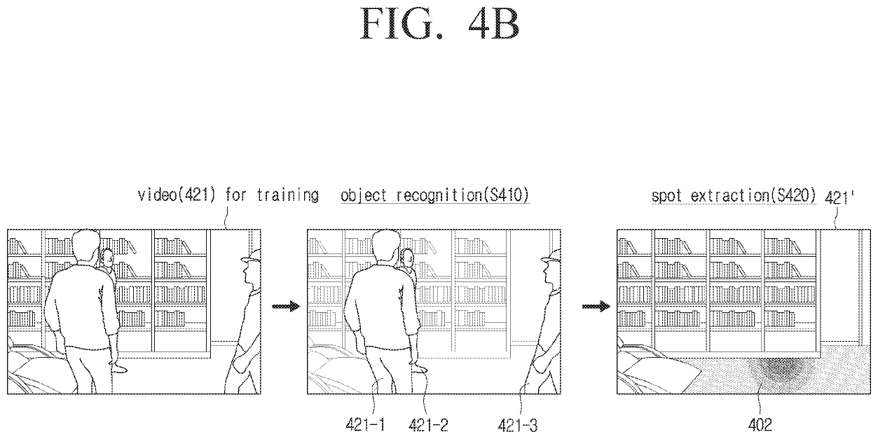

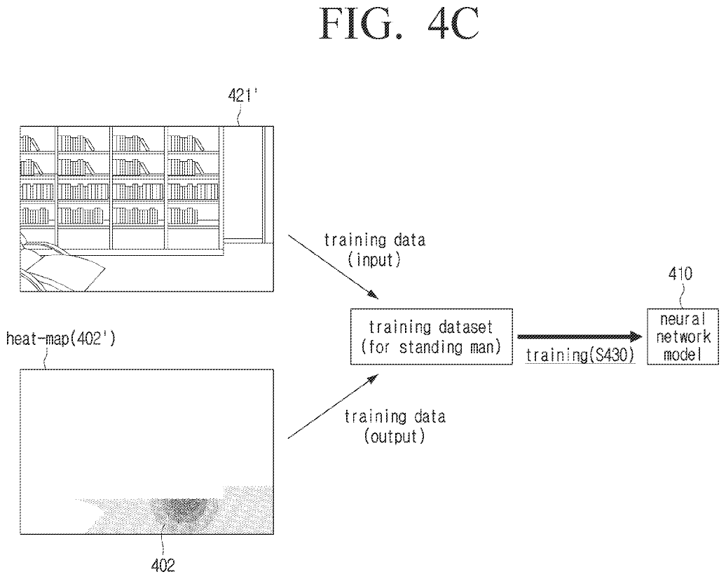

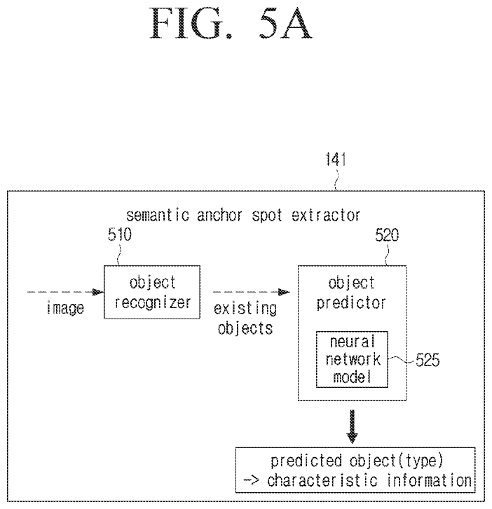

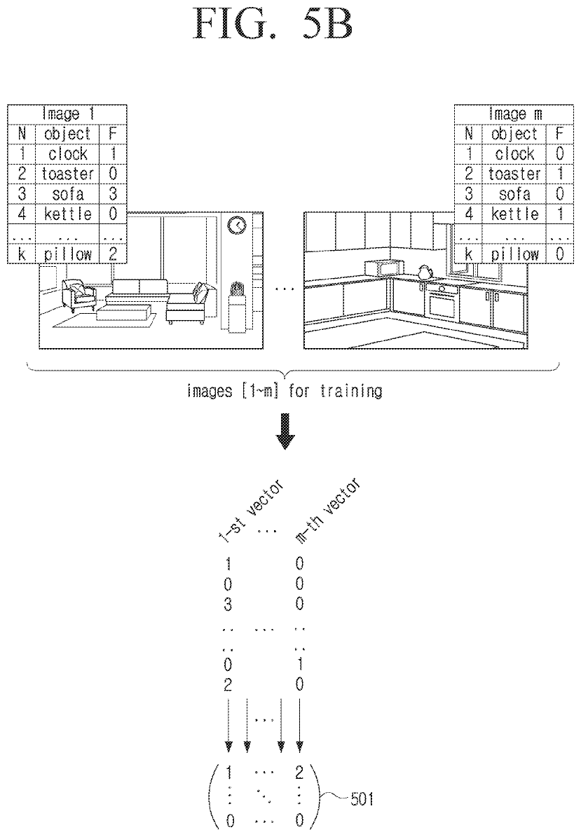

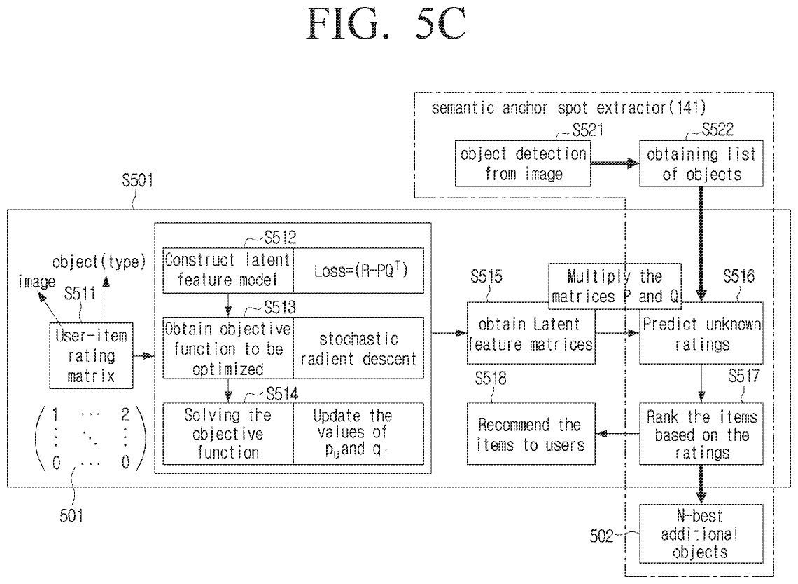

The extractor 141 may extract semantic anchor spots in various other manners and is described in greater detail below with reference to FIGS. 4A, 4B, 4C, 5A, 5B and 5C.

The extractor 141 may track the already identified semantic anchor spot by identifying the semantic anchor spot in real time.

The extractor 141 may identify a position of the semantic anchor spot within the range of the viewing angle imaged through the camera 110.

When a reference angle of the range of the viewing angle imaged through the camera 110 is the same as the reference angle of the range of the viewing angle of the optical display unit 120 (or when previously installed in a predetermined angular relationship), the extractor 141 may determine the position of the semantic anchor spot within the range of the viewing angle at which the user views the optical display unit 120.

The extractor 141 may acquire depth information of the semantic anchor spot through the camera 110 in real time.

When the semantic anchor spot and characteristic information are acquired, the processor 140 may transmit the characteristic information of the semantic anchor spot to the external electronic device 200 through the communication unit 130.

In this case, the processor 230 of the electronic device 200 may recognize at least one object in the video stored in the memory 210 using the received characteristic information.

For example, it may be assumed that the characteristic information received through the communication unit 220 of the electronic device 200 is a ‘person standing’.

In this case, the processor 230 may identify a ‘person standing’ within the image frame included in the video through the semantic object recognizer 231.

To this end, the semantic object recognizer 231 may use at least one artificial intelligence (AI) model for identifying various types of objects.

Even if the corresponding AI model is a form that performs an operation to identify each ‘person standing’, ‘person sitting’, ‘dog’, etc., the semantic object recognizer 231 may control the AI model to drive only a calculation for identifying the ‘person standing’.

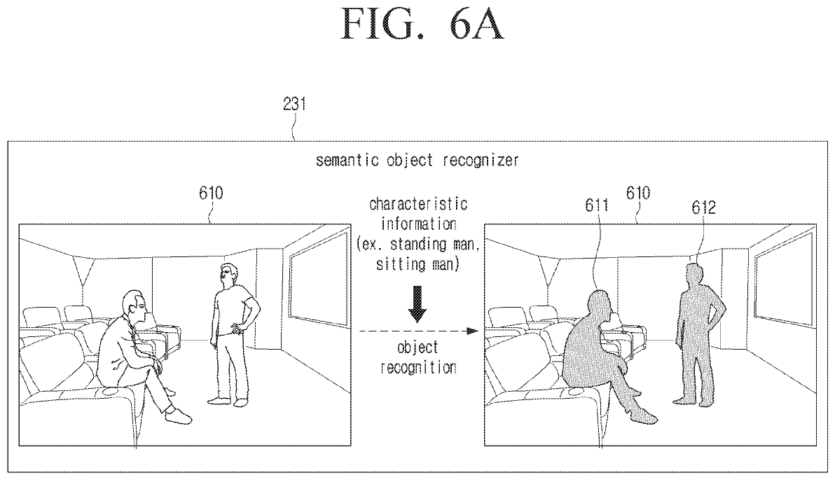

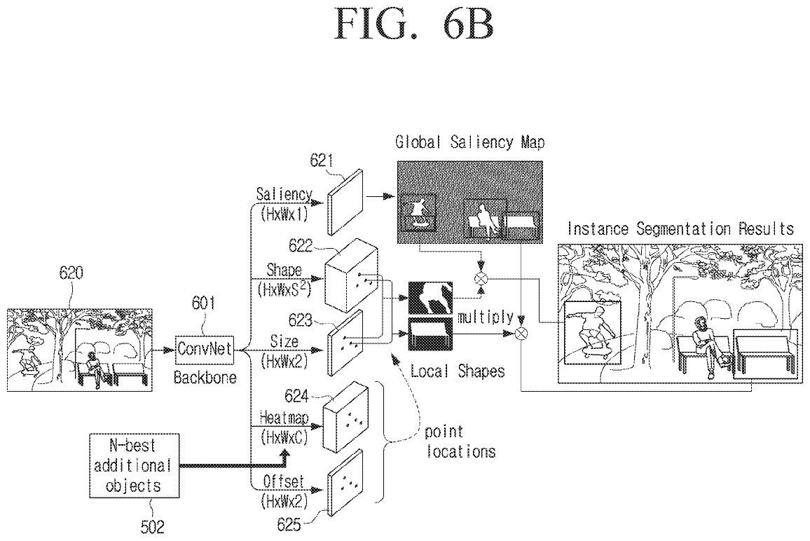

As a result, the amount of calculation of the electronic device 200 performing object recognition may be reduced, and a related specific embodiment will be described later with reference to FIGS. 6A to 6B.

When the object region is recognized according to the characteristic information, the processor 230 may transmit the object region to the MR providing device 100 through the communication unit 220.

In this case, information on the type and size of an object included in the object region may be transmitted together. If a plurality of objects are identified in the image frame of the video, information on a positional relationship (e.g., distance, direction, etc.) of the plurality of objects in the image frame may also be transmitted.

When the object region is received, the processor 140 of the MR providing device 100 may determine a position of the object region through the object positioning module 142.

The object positioning module 142 may include various processing circuitry and/or executable program instructions for determining a position of the received object region within the range of the user's viewing angle.

The object positioning module 142 may receive the position and depth information of the semantic anchor spot from the semantic anchor spot extractor 141. The position of the semantic anchor spot may be a position within the range of the viewing angle of the optical display unit 120.

The object positioning module 142 may determine the position and depth information of the object region according to the position of the semantic anchor spot and the depth information of the semantic anchor spot.

If there are a plurality of semantic anchor spots where the object region may be positioned, the object positioning module 142 may determine a position of the object region according to the position of the semantic anchor spot closest (having a lower depth) to the user (MR providing device).

If a plurality of object regions are received, the object positioning module 142 may determine the position of each of the plurality of object regions using a positional relationship between the pluralities of object regions.

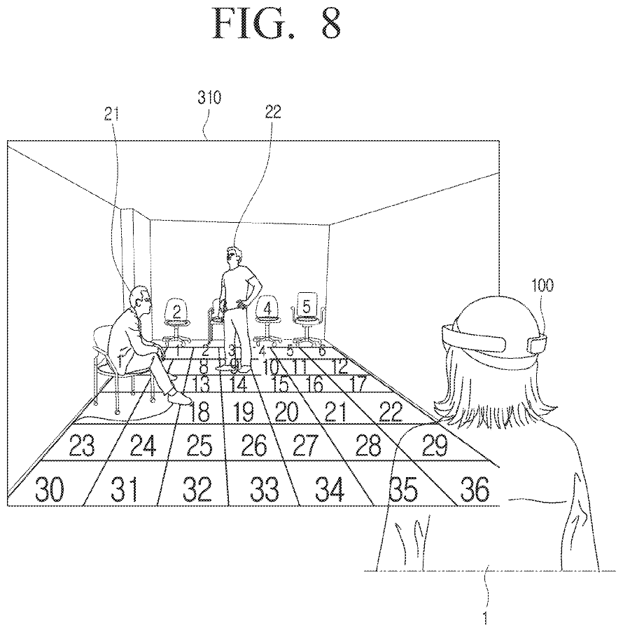

A related embodiment is described in greater detail below with reference to FIG. 8.

The processor 140 may control the optical display unit 120 to display the object region according to the determined position and depth information of the object region.

As a result, the MR providing device 100 may provide the user with a scene in which the object of the video is positioned on the semantic anchor spot in the real space.

FIGS. 3A, 3B and 3C are diagrams illustrating an example operation of an MR providing device identifying a semantic anchor spot based on a horizontal width and height of a horizontal plane according to various embodiments.

The extractor 141 may identify all of the horizontal planes in the image 310 obtained by imaging the real space through the camera 110, and identify at least one of the horizontal planes as a semantic anchor spot using the condition according to the vertical height and horizontal area of the horizontal planes.

The condition of the horizontal plane to become a semantic anchor spot may be previously set to be different for each type of object.

For example, the extractor 141 may identify a horizontal plane in which a vertical height is the lowest among the horizontal planes and a horizontal width is 60 mm or more in width and 60 mm or more in length as a semantic anchor spot in which a person standing may be positioned.

As a result, as shown in FIG. 3A, the extractor 141 may identify the horizontal plane 311 as a semantic anchor spot where a person standing may be positioned.

In addition, the extractor 141 may identify a horizontal plane 312 as a semantic anchor spot where a person sitting may be positioned.

For example, referring to FIG. 3B, the extractor 141 may identify the horizontal plane 312 in which a vertical height of 30 mm or more and less than 90 mm, a horizontal width is 40 mm or more in width and 40 mm or more in length, and the lowest horizontal plane (bottom) is positioned within 20 mm from a point where the edge of the horizontal plane is vertically lowered, as a semantic anchor spot where the person sitting may be positioned.

As a result of the process described above, referring to FIG. 3C, 36 semantic anchor spots where a person standing may be positioned may be identified, and 5 semantic anchor spots where a person sitting may be positioned may be identified.

In addition to the rule-based method illustrated in FIGS. 3A, 3B and 3C, the extractor 141 may identify a semantic anchor spot using at least one AI model.

To this end, when an image is input, the memory of the MR providing device 100 may include an AI model trained to extract a semantic anchor spot included in the input image and characteristic information of the semantic anchor spot.

The extractor 141 may identify at least one semantic anchor spot at which an object may be positioned in the acquired image by inputting the image acquired through the camera into the corresponding AI model.

In relation to this, FIG. 4A is a diagram illustrating an example operation of an MR providing device identifying a semantic anchor spot using an AI model according to various embodiments.

Referring to FIG. 4A, the extractor 141 may input an image 401 of real space captured through the camera 110 into a neural network model 410.

The neural network model 410 may output a semantic anchor spot 402 in the image 401.

As an example, the neural network model 410 may output the semantic anchor spot 402 in the form of a heat map of the semantic anchor spot 402 included in the image 401.

In addition, the neural network model 410 may output characteristic information 403 of the semantic anchor spot 402.

The characteristic information 403 may include information on the type of at least one object (e.g., a person standing) that is highly likely to be positioned at the semantic anchor spot 402.

If there are a plurality of semantic anchor spots, the neural network model 410 may output the number of semantic anchor spots for each type of objects (which may be positioned). For example, the number of semantic anchor spots at which a person standing may be positioned may be 36, and the number of semantic anchor spots at which a person sitting may be positioned may be 5.

In relation to this, FIGS. 4B and 4C are diagrams illustrating an example training process of the neural network model used in FIG. 4A according to various embodiments.

The training process may be performed by the MR providing device 100, but, of course, it may also be performed by at least one other external device.

Referring to FIG. 4B, at least one object may be recognized from a video 421 (S410). In this case, at least one AI model trained to recognize an object (e.g., a person standing) may be used, and the video 421 may include depth information.

When the objects 421-1, 421-2, and 421-3 are recognized, a pixel of the lowest vertical height among a plurality of pixels of each of the objects 421-1, 421-2, and 421-3 may be identified.

It is possible to recognize a horizontal plane 402 closest to the identified pixel (S420). In this case, corresponding horizontal planes may be recognized in an image frame 421′ excluding all the moving objects 421-1, 421-2, and 421-3 on the video 421.

Referring to FIG. 4C, the neural network model 410 may be trained using the image frame 421′ and a heat map 402′ of the horizontal plane 402 as a training dataset (S430).

As a result of training through numerous image-heat map pairs in the same manner, the neural network model 410 may identify a semantic anchor spot (hit map) where an object (e.g., a person standing) may be positioned in the input image.

Although it is categorically premised that the object that may be positioned on the lowest horizontal plane is a ‘person standing’ through the embodiment of FIG. 3A described above, in addition to this, various types of objects (e.g., dog, cat, etc.) may be positioned on the corresponding horizontal plane.

As an example, the corresponding horizontal plane may be identified as a semantic anchor spot having characteristic information where various objects such as a person standing, a dog, and a cat are likely to be positioned. This is possible as the characteristic information of the semantic anchor spot is implemented in the form of a vector that quantifies the possibility of each type of object.

However, according to the characteristic information, there may be a problem in that the types of objects that may be positioned at the semantic anchor spot are too many.

In this case, a time taken for the semantic object recognition performed by the electronic device 200 may increase, and the number of object regions received from the electronic device 200 to the MR providing device 100 may be excessively increased.

Therefore, according to an embodiment, the extractor 141 may predict a type of object that may be additionally positioned on the corresponding space (semantic anchor spot) using the number of types of objects existing in the real space.

The extractor 141 may update the characteristic information of the semantic anchor spot (corresponding horizontal plane) to include only the predicted type of object.

In relation to this, FIG. 5A is a diagram illustrating an example operation of predicting an object that may be positioned at a semantic anchor spot using the number of existing objects per type by the MR providing device according to various embodiments.

FIG. 5A assumes that at least one semantic anchor spot (e.g., a horizontal plane) has already been identified.

Referring to FIG. 5A, the extractor 141 may include an object recognizer 510 and an object predictor 520, each of which may, for example, include various processing circuitry and/or executable program instructions.

The object recognizer 510 may identify at least one (existing) object included in the image (real space) acquired through the camera 110. In this case, at least one AI model trained to identify various types of objects may be used.

The object predictor 520 may identify (predict) the type of object that may be positioned at a semantic anchor spot based on the identified type of object.

The object predictor 520 may use an AI model 525 trained to output the types of objects that may additionally exist when the number of each type of object is input. This AI model may be stored in the memory of the MR providing device 100.

For example, the object predictor 520 may input the number of identified objects into the AI model 525 for each type, and determine the type of at least one object that may additionally exist.

In this case, the extractor 141 may update/generate characteristic information of a semantic anchor spot according to the determined (object) type.

FIG. 5B is a diagram illustrating an example of generating training data for training the AI model used in FIG. 5A according to various embodiments.

Referring to FIG. 5B, object recognition may be performed on k types (classes) in each of m images (images [1-m]).

As a result, for each image, recognition results for k types (classes) of objects may be calculated as the number of objects per type.

A matrix 501 as training data may be obtained according to the calculated number of objects for each type.

The AI model 525 may be trained using the matrix 501 as training data.

In this connection, FIG. 5C is a block diagram illustrating an example in which an MR providing device trains the AI model 525 of FIG. 5A using the training data 501 acquired in FIG. 5B and predicts an object using the trained AI model 525 according to various embodiments.

FIG. 5C may use the concept of a “Market Basket Analysis” of the related art. Market Basket Analysis is for determining which items are frequently purchased together by customers.

Similarly, according to an embodiment of the present disclosure, it is determined which objects exist together in one image (or real space).

Accordingly, the matrix 501 of FIG. 5B including information on the number of types of objects identified together for each image may be training data.

In FIG. 5C, S501 (S511, S512, S513, S514, S515, S516, S517 and S518 which may be referred to hereinafter as S511 to S518) adopts a process of training and rating described in “A Survey of Collaborative Filtering-Based Recommender Systems: From Traditional Methods to Hybrid Methods Based on Social Networks” (Rui Chen, Qinhyi Hua, et al.), the disclosure of which is incorporated by reference herein in its entirety, as an example of training and rating.

In the process S511, it is necessary to replace “user” with “image” and “item” with “object (type)”. As training data of S511, the matrix 501 obtained in FIG. 5B may be used.

As a result, the AI model 525 of FIG. 5A may be trained to predict at least one object that is highly likely to additionally exist in the image through the process of S511 to S515.

As a result, the extractor 141 may recognize an object from an image (obtained by imaging real space) (S521) and acquire a list of identified objects (S522).

As a result of inputting the list of identified objects into the model 525 (S516 and S517), the extractor 141 may acquire a list 502 of objects (types) that are most likely to exist additionally in the real space.

The extractor 141 may define characteristic information of the semantic anchor spot pre-identified according to the list 502.

FIG. 6A is a diagram illustrating an example operation of an electronic device recognizing an object in a video based on characteristic information according to various embodiments.

Referring to FIG. 6A, the semantic object recognizer 231 of the electronic device 200 may extract at least one object region from the image frame 610 included in the video using the characteristic information received from the MR providing device 100.

For example, it may be assumed that the types of objects (characteristic information) that may be positioned at the semantic anchor spot are a person standing and a person sitting.

In this case, referring to FIG. 6A, the semantic object recognizer 231 may identify the object region including the person sitting 611 and the object region including the person standing 612 from the image frame 610, respectively.

In this case, the semantic object recognizer 231 may use at least one AI model trained to identify an object corresponding to the characteristic information.

As an example, it is assumed that an AI model trained to identify a plurality of types of objects is stored in the memory 210 of the electronic device 200. An object recognition method may include a keypoint estimation method, a bounding box method (1, 2 stage, etc.).

The semantic object recognizer 231 may select a type corresponding to the characteristic information (e.g., the person standing and the person sitting) among a plurality of types and control the AI model to identify the selected type of object within the image frame.

In this connection, FIG. 6B is a diagram illustrating an example operation in which an electronic device recognizes an object in a video based on characteristic information (a predicted object list) according to various embodiments.

FIG. 6B adopts a semantic object recognition algorithm described in “CenterMask: single shot instance segmentation with point representation” (Yuqing Wang, Zhaoliang Xu, et al.), which is incorporated by reference herein in its entirety, as an example in an object recognition process.

Referring to FIG. 6B, the semantic object recognizer 231 may input an image frame 620 included in a video to a ConvNet 601, which may include, for example, a backbone network.

Here, there are five heads after the ConvNet 601, and outputs from the five heads 621, 622, 623, 624, and 625 have the same height (H) and width (W), but are different in channel number. C is the number of types (classes) of objects. Also, S² is a size of a shape vector.

In FIG. 6B, a heat map head may predict a position and category (type of object) of each of the center points according to the conventional keypoint estimation pipeline.

In this case, each channel of the output 624 corresponds to the heat map of each category (type of object).

Here, the semantic object recognizer 231 according an embodiment may control calculation of the heat map head to output only a heat map of a category matched to the type of the object included in the characteristic information (e.g., the list 502 of FIG. 5C) according to the received characteristic information.

For example, among all the heat map layers, only the heat map layer of a category matching the type of object included in the characteristic information may perform calculation, thus reducing the amount of calculation.

The outputs 624 and 625 of the heat map head and an offset head indicate positions of the center points. In this case, the center points may be separately obtained for different types of objects. The shape and size heads predict local shapes at the corresponding position of the center point. A saliency head outputs a global saliency map 621, and an object region cropped on the global saliency map may be multiplied by local shapes to form a mask representing each object on the image frame 620. A final object recognition may be completed according to the formed mask.

As such, as the characteristic information of the semantic anchor spot is used for object recognition, the object recognition speed of the electronic device 200 may be increased. This is a very positive factor for real-time streaming

Although object recognition according to the center point method is used in FIG. 6A described above, FIG. 6A is only an example and the object recognition method of the semantic object recognizer 231 is not limited only to the center point method as in FIG. 6A and various methods such as bounding box (1 size patch, multi-size patch, etc.)-based object recognition and edge point-based object recognition may be used.

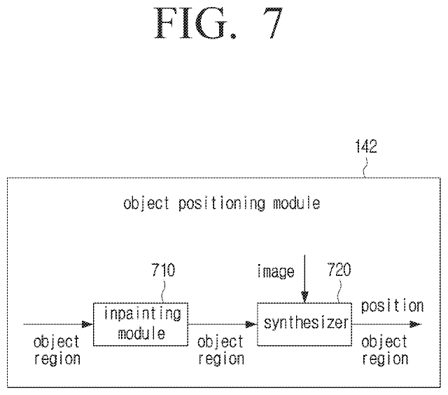

FIG. 7 is a diagram illustrating an example operation in which the MR providing device determines a position of an object region to be displayed within a user's field of view according to various embodiments.

Referring to FIG. 7, the object positioning module 142 of the MR providing device 100 may include at least one of an inpainting module 710 and a synthesizer 720.

The inpainting module 710 is a module for compensating for an incomplete part present in the object region received from the electronic device 200.

For example, the inpainting module 710 may newly create an omitted part from an object included in the object region received from the electronic device 200.

For example, a case in which a part (e.g., a lower part of the right leg) of an object (e.g., a person standing) is obscured by another object within an image frame of a video of the electronic device 200 or a case in which only a body part, not all of the object (e.g., a person standing), are shown inside an image frame may be assumed.

In this case, in an extracted object region, a part (e.g., the lower part of the right leg) of the object (e.g., a person standing) may not be included.

Here, the inpainting module 710 may determine whether an appearance of the object (e.g., a person standing) included in the object region received from the electronic device 200 is complete, and may supplement the object region by generating the incomplete part (e.g., the lower part of the right leg).

As a result, a part of the object that was not previously included in the video may be generated to fit the existing parts of the object, and the user may be provided with a virtual object image in a complete shape through the MR providing device 100.

To this end, the inpainting module 710 may use at least one GAN for supplementing at least a part of an incompletely drawn object, and a conventional technology (e.g., SeGAN: Segmenting and Generating the Invisible. Kiana Ehsani, Roozbeh Mottaghi, et al.) for reconstructing an object partially omitted in the image may be used.

The synthesizer 720 is a module for synthesizing an object region within the range of the viewing angle of the user viewing the real space. The synthesizer 720 may determine the position and/or the depth of the object region to be displayed within the range of the user's viewing angle.

According to an embodiment, the synthesizer 720 may determine the position of the object region using the distance between the MR providing device 100 and the semantic anchor spot, the position in the image frame (video) of the object region, etc.

FIG. 8 is a diagram illustrating an example operation in which an MR providing device determines positions of object regions using a distance between the MR providing device and a semantic anchor spot and a positional relationship between the object regions according to various embodiments.

FIG. 8 assumes that 36 semantic anchor spots at which a person standing may be positioned and 5 semantic anchor spots at which a person sitting may be positioned are identified. In FIG. 8, it is assumed that the object regions 21 and 22 (corresponding to the characteristic information) received from the electronic device 200 include a person sitting and a person standing, respectively. The image 310 is an image of real space captured by the camera 110.

A synthesizer 720 may select a semantic anchor spot having a relatively close distance to the MR providing device 100.

Referring to FIG. 8, the synthesizer 720 may determine a position of a first semantic anchor spot, among the semantic anchor spots where the person sitting may be positioned, as the position of the object region 21.

In addition, the synthesizer 720 may determine the position of the object region 22 in consideration of the determined position of the object region 21 so that the positional relation (e.g., distance, direction, etc.) between the object regions 21 and 22 in the image frame (e.g., 20 of FIG. 1) of the video is maintained.

As a result, referring to FIG. 8, the synthesizer 720 may determine the ninth semantic anchor spot among 36 semantic anchor spots where a person standing may be positioned as the position of the object region 22.

However, FIG. 8 is only an example, and a method of using a distance between the MR providing device 100 and the semantic anchor spot and/or the positional relationship between object regions is not limited to the example of FIG. 8 and may be variously modified at the technical level.

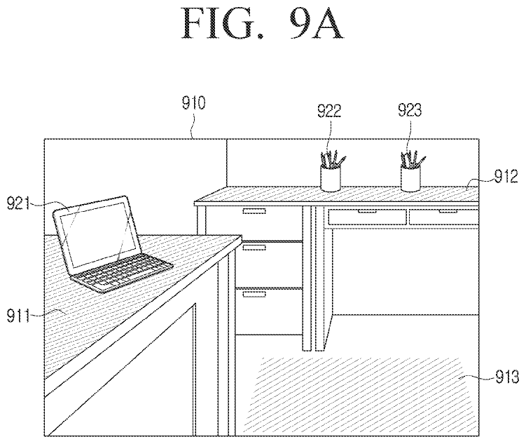

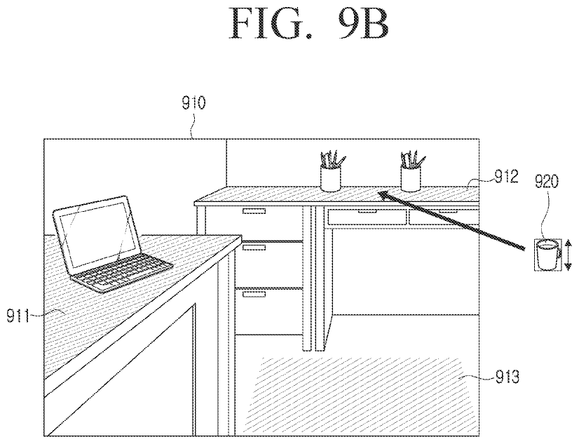

The synthesizer 720 may determine a position of an object region to be newly added according to the type and/or size of the object existing on each semantic anchor spot. Hereinafter, an example will be described in greater detail below with reference to FIGS. 9A and 9B.

FIG. 9A assumes that three semantic anchor spots 911, 912, and 913 are identified in real space 910.

In addition, in FIG. 9A, it is assumed that the notebook 921 exists on a semantic anchor spot 911, and pencil holders 922 and 923 exist on the semantic anchor spot 912. The objects 921, 922, and 923 may be those recognized by the extractor 141 described above.

The synthesizer 720 may identify the types of the existing objects (notebook, pencil case, etc.) and the size of each object. As a result, information on the types and sizes of objects existing in each of the semantic anchor spots 911, 912, and 913 may be acquired.

When the received object region 920 includes a cup as shown in FIG. 9B, the synthesizer 720 may select at least one semantic anchor spot according to a size (e.g., height) of the cup.

Referring to FIG. 9B, the size/height of the pencil holders 922 and 923 existing at the semantic anchor spot 912 among the objects existing in the real space 910 is most similar to the size/height of the cup, the synthesizer 720 may select semantic anchor spot 912 as a position of the object region 920.

According to an embodiment, the synthesizer 720 may use a GAN for synthesizing an object region with an image of real space captured by the camera 110.

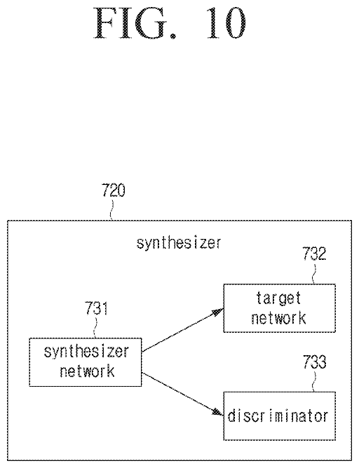

In this connection, FIG. 10 is a diagram illustrating an example operation in which an MR providing device determines a position of an object region using a GAN model according to various embodiments.

Referring to FIG. 10, the synthesizer 720 may use a synthesizer network 731, a target network 732, a discriminator 733, and the like corresponding to a GAN.

The synthesizer network 731 may refer to a network trained to generate a synthetic image by synthesizing an object region in an image, and is updated to deceive the target network 732.

The target network 732 may also be trained through a synthetic image, and the discriminator 733 may provide feedback to the synthesizer network 731 to improve a quality of the synthesized image, so that the target network 732 may be trained based on a large number of real images.

However, the example of FIG. 10 uses an example of the related art (Learning to Generate Synthetic Data via Compositing. Shashank Tripathi, Siddhartha Chandra, et al., which is incorporated by reference herein in its entirety), and in addition, various types/methods of GAN may be used.

According to an embodiment, the synthesizer 720 may use a GAN trained to output a saliency map including information on an object that may be positioned in an image when the corresponding image not including an object is input.

Using the saliency map indicating a position (coordinates) of an object in a relatively simple form (binary mask), a position of the object region to be arranged on the visual field of the user who is viewing the real space may be quickly determined.

In this case, in order to train the GAN, an image frame including an object and an image frame representing the same space but not including an object are required.

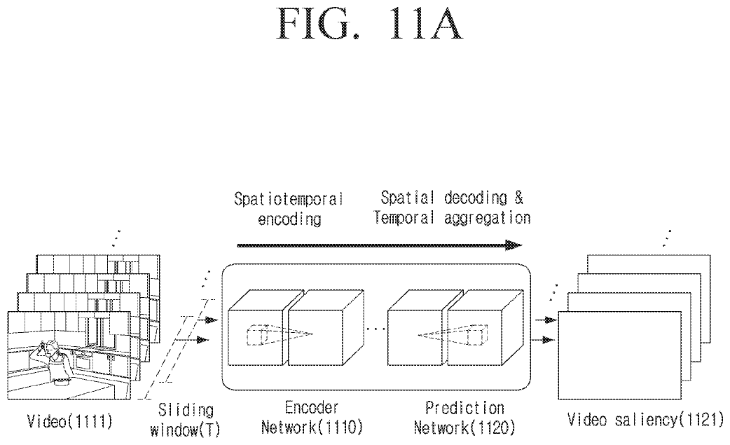

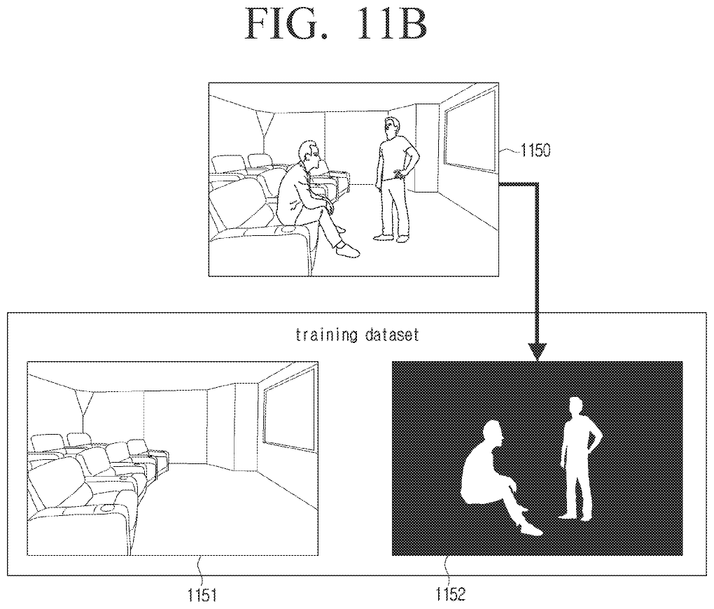

FIGS. 11A to 11B illustrate an example of a process of training the corresponding GAN according to various embodiments.

Referring to FIG. 11A, an encoder network 1110 for sequentially receiving a plurality of image frames included in a video 1111 and extracting spatiotemporal features and a prediction network 1120 for extracting information on an object from the spatiotemporal features in the form of a saliency map 1121 may be used (Refer, for example, to: TASED-Net: Temporally-Aggregating Spatial Encoder-Decoder Network for Video Saliency Detection. Kyle Min, Jason J. Corso, which is incorporated by reference herein in its entirety).

As a result, a pair of an image frame including an object and a saliency map including information on the object may be acquired. In addition, an image frame that represents the same space as the corresponding image frame but not including an object is required.

Referring to FIG. 11B, an image frame 1151 not including an object and a saliency map 1152 may be a training data set of the GAN as input/output, respectively.

The saliency map 1152 may be acquired by inputting an image frame 1150 including an object to the networks 1110 and 1120 as shown in FIG. 11A.

As a result of the process of FIGS. 11A to 11B, the GAN of the synthesizer 720 may determine a position of an object region to be added in the image obtained by imaging the real space.

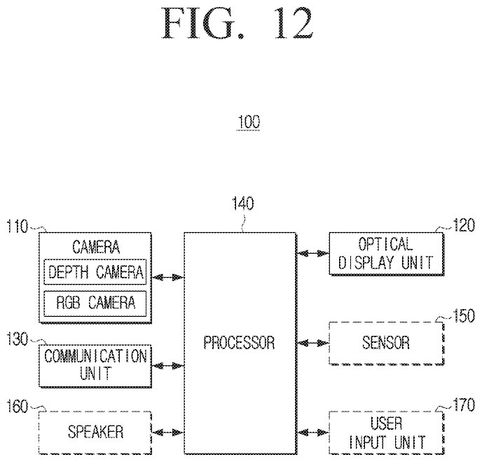

FIG. 12 is a block diagram illustrating an example configuration of an MR providing device according to various embodiments.

Referring to FIG. 12, the MR providing device 100 may further include a sensor 150, a speaker 160, a user input unit (e.g., including input circuitry) 170, and the like, in addition to the camera 110, the optical display unit 120, the communication unit 130, and the processor 140.

The communication unit 130 may include various communication circuitry and perform communication with various external devices in addition to the external electronic device 200 described above.

For example, at least one of the operations of the processor 140 described above may be performed through at least one external control device capable of communicating with the MR providing device 100 through the communication unit 130.

For example, in order to reduce a volume of the MR providing device 100, a separate external computing device performing most of the functions of the processor 140 described above may be connected to the MR providing device 100 through the communication unit 130.

In addition, if there is a separate remote control device for inputting a user instruction for the MR providing device 100, information on the user instruction input through the remote control device (e.g., user motion input device) may also be received through the communication unit 130.

The communication unit 130 may communicate with one or more external devices through wireless communication or wired communication.

Wireless communication may include at least one of long-term evolution (LTE), LTE Advance (LTE-A), 5th Generation (5G) mobile communication, code division multiple access (CDMA), wideband CDMA (WCDMA), universal mobile telecommunications system (UMTS), wireless broadband (WiBro), global system for mobile communications (GSM), time division multiple access (DMA), WiFi, WiFi Direct, Bluetooth, near field communication (NFC), Zigbee, etc.

Wired communication may include at least one of communication methods such as Ethernet, optical network, universal serial bus (USB), and ThunderBolt. Here, the communication unit 130 may include a network interface or a network chip according to the wired/wireless communication method described above.

The communication unit 130 may be directly connected to an external device, but may also be connected to an external device through one or more external servers (e.g., Internet service provider (ISP)) and/or a relay device providing a network.

The network may be a personal area network (PAN), a local area network (LAN), a wide area network (WAN), etc. depending on an area or scale, and may be Intranet, Extranet, or the Internet, etc. depending on openness of the network.

The communication method is not limited to the example described above and may include a communication method that appears newly as technology develops.

The processor 140 may be connected to at least one memory of the MR providing device 100 to control the MR providing device 100.

The processor 140 may include various processing circuitry including, for example, and without limitation, at least one of a central processing unit (CPU), a dedicated processor, a graphic processing unit (GPU), a neural processing unit (NPU), etc. In hardware and may execute operations or data processing related to control of other components included in the MR providing device 100.

The processor 140 may control not only hardware components included in the electronic device 200 but also one or more software modules included in the MR providing device 100, and results of controlling the software modules by the processor 140 may be derived as operations of the hardware components.

The processor 140 may be configured as one or a plurality of processors. In this case, one or the plurality of processors may be general-purpose processors such as CPUs and APs, graphics-only processors such as GPUs and VPUs, or AI-only processors such as NPUs.

The one or a plurality of processors control to process input data according to a predefined operation rule or AI model stored in the memory. The predefined operation rule or AI model is made through learning (training).

Being made through learning may refer, for example, to a predefined operation rule or AI model having desired characteristics being made by applying a learning algorithm to a plurality of learning data. Such learning may be performed in a device itself in which the AI according to the present disclosure is performed, or may be performed through a separate server/system.

The learning algorithm may refer, for example, to a method of training a predetermined target device (e.g., a robot) using a plurality of learning data so that the predetermined target device may make a decision or make a prediction by itself. Examples of the learning algorithm include supervised learning, unsupervised learning, semi-supervised learning, or reinforcement learning, and the learning algorithm in the present disclosure is not limited to the examples mentioned above, except for a specified case.

The sensor 150 is a component for acquiring surrounding information of the MR providing device 100.

The sensor 150 may include various sensors such as, for example, and without limitation, an inertial measurement unit (IMU) sensor, a global positioning system (GPS) sensor, a geomagnetic sensor, or the like.

The processor 140 may configure a 3D map of real space viewed by the user through the MR providing device 100 by performing simultaneous localization and mapping (SLAM) using depth information (e.g., lidar sensor data) and/or IMU sensor data acquired through a depth camera, and track a position of the MR providing device 100 (user) on the map.

The operation of the extractor 141 for identifying a horizontal plane (a candidate of a semantic anchor spot) in real space described above may also be performed in the SLAM process.

The processor 140 may perform visual SLAM using an image acquired through a stereo camera.

The speaker 160 is a component for outputting sound.

When an audio signal included in a video is received from the electronic device 200, the processor 140 may control the speaker 160 to output a sound corresponding to the received audio signal.

Object regions may be provided visually and sound of the video may be provided aurally.

The user input unit 170 may include various components and/or circuitry for receiving user instructions/information.

The user input unit 170 may include various components such as at least one button, a microphone, a touch sensor, and a motion sensor.

In addition, when the MR providing device 100 is implemented as an HMD or AR/MR glasses, the user input unit 170 may include at least one contact/proximity sensor for determining whether the user wears the MR providing device 100.

For example, in a state in which the MR providing device 100 is worn, when a user instruction for activating an immersive mode is received, the processor 140 may perform communication with the electronic device 200 and also perform the operations described above using the extractor 141 and the object positing module 142.

As a result, at least a portion (object region, sound) of a video provided by the electronic device 200 may be provided in real space through the MR providing device 100.

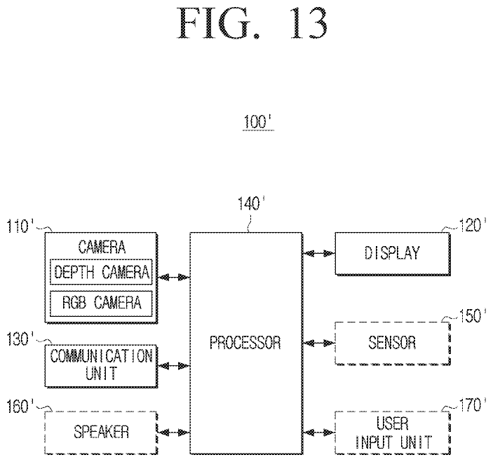

FIG. 13 is a block diagram illustrating an example configuration of an MR providing device that provides MR using a display according to various embodiments.

Through the above drawings, various embodiments in which the MR providing device 100 uses the optical display unit 120 have been described, but an MR providing device 100′ using a general display 120′ instead of the optical display unit 120 may also be an embodiment of the present disclosure.

The present MR providing device 100′ may be implemented, for example, and without limitation, as a smartphone, a tablet PC, or the like.

The present MR providing device 100′ is the same as or similar to the MR providing device 100 described above in that it performs the operation of the extractor 141 and receives an object region according to characteristic information, but different from the MR providing device 100 in a process of providing MR finally.

For example, when an object region according to the characteristic information of the semantic anchor spot is received from the electronic device 200, the processor 140′ may include various processing circuitry and synthesize the corresponding object region to an image obtained by imaging real space through the camera 110. In this case, at least one GAN may be used.

The processor 140′ may control the display 120′ to display the synthesized image.

For example, the MR providing device 100′ may not display a virtual image (object region) in real space using the optical display unit 120, but may generate a composite image obtained by synthesizing the captured image of real space and a virtual image and display the generated composite image.

In this case, there is a problem in that the real space itself is seen through a delay, but there is an advantage that MR may be provided even with an existing smartphone or tablet PC.

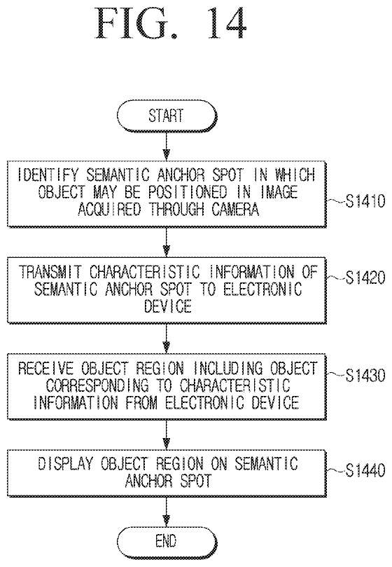

FIG. 14 is a flowchart illustrating an example method of controlling an MR providing device according to various embodiments. The MR providing device may provide real space and virtual images within a preset range of viewing angle and may include an optical display unit and/or a display.

Referring to FIG. 14, an example controlling method of the present disclosure may acquire an image (of real space) by imaging a preset range of viewing angle through a camera. In this case, the camera may include an RGB camera and/or a depth camera.

Also, at least one semantic anchor spot in which an object may be positioned may be identified in the acquired image (S1410).

In this case, depth information of a plurality of pixels of the image acquired through the camera may be acquired, and at least one horizontal plane may be identified in the acquired image based on the acquired depth information.

Based on a width of the at least one identified horizontal plane and height thereof in a vertical direction, a semantic anchor spot in which an object may be positioned in the at least one identified horizontal plane may be identified.

It may be assumed that a memory of the MR providing device includes an AI model trained to extract a semantic anchor spot and characteristic information included in the input image when an image is input.

In this case, at least one semantic anchor spot in which an object may be positioned may be identified in the acquired image by inputting the image acquired through the camera into the AI model.

The control method of the present disclosure may identify at least one object included in the acquired image. Based on a type of the identified object, the type of object that may be positioned at the semantic anchor spot may be determined.

In this case, based on the determined type of object, characteristic information of the semantic anchor spot may be generated.

As an example, the memory of the MR providing device may include an AI model trained to output the types of objects that may additionally exist when the number of types of objects is input.

In this case, by inputting the number of objects identified from the acquired image to the AI model for each type, the type of at least one object that may additionally exist may be determined.

When the semantic anchor spot and characteristic information thereof are identified (S1410) according to the embodiments described above, in the control method, characteristic information of the semantic anchor spot may be transmitted to an external electronic device (S1420).

In this case, the electronic device may extract an object region for each image frame by identifying and tracking the object according to the characteristic information from the image frame of the video.

An object region including an object corresponding to characteristic information among at least one object included in the image frame of the video provided by the electronic device may be received from the electronic device (S1430).

In the control method of the present disclosure, the received object region may be displayed on the semantic anchor spot (S1440).

In the control method of the present disclosure, a position where the object region is to be displayed may be determined, and the object region may be displayed according to the determined position.

As an example, in the control method of the present disclosure, a distance between the MR providing device and the semantic anchor spot and/or position information of the object region in the image frame of the video may be used.

As an example, it is assumed that a plurality of semantic anchor spots are identified in the acquired image and a plurality of object regions are received from the electronic device.

Based on the distance between each of the plurality of semantic anchor spots and the MR providing device and the positional relationship between the plurality of object regions within the image frame, semantic anchor spots in which each of the plurality of received object regions, among the plurality of semantic anchor spots, is to be positioned may be selected.

The plurality of object regions may be displayed on the selected semantic anchor spots, respectively.

When a plurality of semantic anchor spots are identified, the type or size of the object present at each of the plurality of semantic anchor spots in the captured image of the real space may be identified together.

In this case, based on the type or size of the identified object, a semantic anchor spot at which the received object region is to be positioned may be selected from among the plurality of semantic anchor spots. The received object region may be displayed on the selected semantic anchor spot.

A position at which the received object region is displayed may be identified by inputting the acquired image (real space) to the GAN trained to synthesize at least one object region in the image. In this case, based on the identified position, the received object region may be displayed.

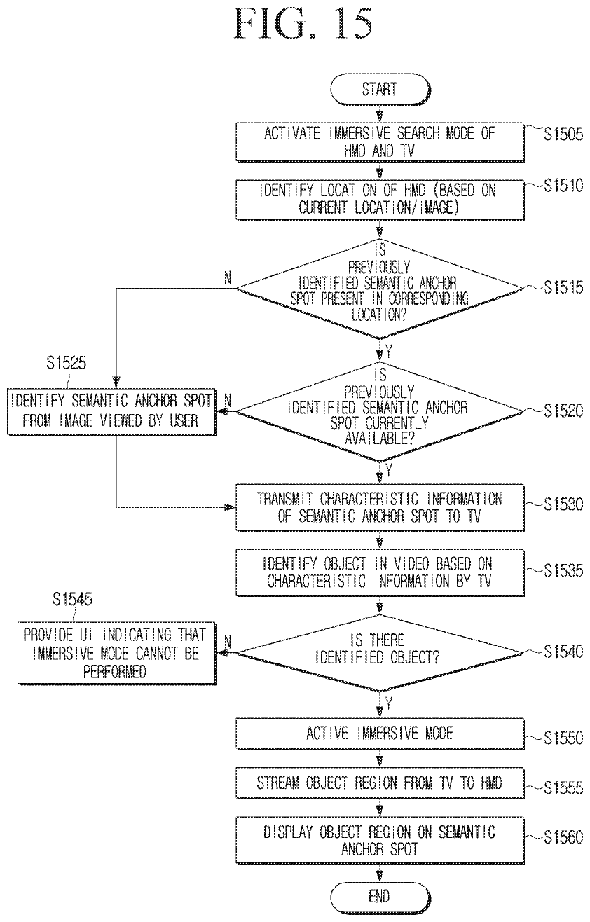

FIG. 15 is a flowchart illustrating an example algorithm of an MR providing device and a method of controlling an electronic apparatus according to various embodiments.

In FIG. 15, it is assumed that the MR providing device is implemented as an HMD and the electronic device is implemented as a TV providing video content. In addition, in FIG. 15, it is assumed that the HMD is worn by the user and the HMD and the TV may communicate with each other.

Referring to FIG. 15, an immersive search mode of the HMD and the TV may be activated (S1505).

The immersive search mode corresponds to a mode for determining whether an immersive mode that provides MR in which real space and video are combined.

As an example, the immersive search mode of the HMD and the TV may be activated according to a user instruction input to the HMD.

In this case, the HMD may identify a current position of the user (HMD) (S1510). In this case, a GPS sensor may be used or at least one repeater (e.g., a WiFi router) may be used. The current position may be identified by comparing an image obtained by imaging the surroundings of the HMD with pre-stored images of various positions.

It may be identified whether there is a previously identified semantic anchor spot in a corresponding place (S1515).

In this case, the HMD may use history information in which the semantic anchor spot is identified at the current position. The history information may include information stored by matching the semantic anchor spot identified by the HMD and characteristic information thereof to the position where the semantic anchor spot is identified.

If there is a previously identified semantic anchor spot (S1515-Y), the HMD may determine whether the corresponding semantic anchor spot is currently available (S1520). For example, it is possible to identify whether other objects have already been placed on the corresponding spot.

When the semantic anchor spot is available (S1520-Y), characteristic information of the corresponding semantic anchor spot may be transmitted to the TV (S1530).

If there is no previously identified semantic anchor spot (S1515-N) or if the previously identified semantic anchor spot is not currently available (S1520-N), the HMD may identify a semantic anchor spot from an image (captured through the camera) viewed by the user (S1525).

The characteristic information of the identified semantic anchor spot may be transmitted to the TV (S1530).

The TV may identify an object in the video based on the received characteristic information (S1535).

If an object matching the characteristic information is not identified within the image frame of the video (S1540-N), the TV may transmit information indicating that there is no available object region to the HMD. In addition, the HMD may visually (virtual image) or aurally provide a user interface (UI) indicating that the immersive mode cannot be performed (S1545).

When an object matching the characteristic information is identified within the image frame of the video (S1540-Y), the TV may transmit information indicating that there is an available object region to the HMD. In this case, the immersive mode of the HMD and the TV may be activated (S1550).

The HMD may provide the user with a UI for inquiring whether to activate the immersive mode. In addition, when a user instruction for activating the immersive mode is input, the immersive mode of the HMD and the TV may be activated.

When the immersive mode is activated, the TV may stream the identified object region for each image frame to the HMD (S1555).

The HMD may display the object region received in real time as a virtual image on the semantic anchor spot (S1560). As a result, an MR in which the real space and the object region of the video are combined may be provided.

In addition, various application examples are may be provided.

As an embodiment, the MR providing device may select a semantic anchor spot in real space according to a user instruction input through motion or the like.

In this case, an object to be positioned at the corresponding semantic anchor spot may also be selected according to a user instruction (e.g., user's voice).

For example, when a talk show is to be streamed, spots at which each person in the talk show is positioned may be set according to a user instruction.

According to an embodiment, when the immersive mode of the MR providing device is activated, the MR providing device may set the size of the object region to be provided to be different according to a user's command

For example, when streaming a talk show, the MR providing device may provide a UI for receiving a selection of either full or small to the user.

If full is selected, the MR providing device may display the object regions of the people in the talk show on the semantic anchor spots (e.g., floor, sofa, chair, etc.) in an actual size of the people.

When small is selected, the MR providing device may display the object regions of the people in the talk show in a size much smaller than the actual size on the semantic anchor spots (e.g., a dining table, a plate, etc.). In this case, the people in the talk show may be expressed in a very small size.

That is, even in the object region including the same object, the semantic anchor spot at which the object region is positioned may vary depending on the size in which the object region is provided.

The MR providing device and/or the method of controlling an electronic device described above may, for example, be performed through the MR providing device 100 or 100′ and/or the electronic device 200 illustrated and described with reference to FIGS. 2, 12, and 13, etc.

The MR providing device and/or method of controlling an electronic device described above may, for example, be performed through a system further including at least one external device in addition to the MR providing device 100 or 100′ and/or the electronic device 200.

According to the various example embodiments described above, the user wearing the MR providing device may be provided with video content, while doing various things (e.g., eating, studying, cooking, etc.) in real space. Unlike simply displaying a virtual TV on a wall in real space, users do not need to look away and may experience more immersive MR.

Various embodiments described above may be implemented in a computer or similar device-readable recording medium using software, hardware, or a combination thereof.

In the case of implementation by hardware, embodiments described in this disclosure may be implemented using at least one of application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, electronic units performing other functions.

In some cases, the embodiments described herein may be implemented by the processor itself. In the case of software implementation, embodiments such as procedures and functions described in this disclosure may be implemented as separate software modules. Each of the software modules may perform one or more functions and operations described in this disclosure.

Computer instructions for performing a processing operation in the MR providing device 100 and/or the electronic device 200 according to various embodiments of the present disclosure described above may be stored in a non-transitory computer-readable medium. When the computer instructions stored in such a non-transitory computer-readable medium are executed by a processor of a specific device, the specific device mentioned above may perform the processing operation in the MR providing device 100 and/or the electronic device 200 according to the various embodiments described above.

A non-transitory readable medium refers to a medium that semi-permanently stores data and can be read by a device. For example, the non-transitory readable medium may include a CD, DVD, hard disk, Blu-ray disc, USB, memory card, or ROM.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents.

What is claimed is:

1. A mixed reality (MR) providing device comprising:
a camera;
a communication unit comprising communication circuitry configured to communicate with an electronic device providing video;
an optical display unit comprising an optical display configured to simultaneously display real space within a preset range of viewing angle and a virtual image; and
a processor connected to the camera, the communication unit, and the optical display unit,
wherein the processor is configured to: control the camera to acquire an image by capturing the preset range of viewing angle, identify at least one semantic anchor spot of the acquired image in which an object may be positioned, control the communication unit to transmit characteristic information of the semantic anchor spot related to the object that may be positioned to the electronic device, control the communication unit to receive an object region including the object corresponding to the characteristic information among at least one object included in an image frame of the video from the electronic device, and control the optical display unit to display the received object region on the semantic anchor spot.

2. The MR providing device as claimed in claim 1, wherein
the camera includes a depth camera,
the processor is configured to: acquire depth information of a plurality of pixels of an image acquired through the camera,
identify at least one horizontal plane in the acquired image based on the acquired depth information, and
identify a semantic anchor spot in which an object may be positioned in at least one of the identified horizontal plane based on an area and a height in a vertical direction of at least one of the identified horizontal plane.

3. The MR providing device as claimed in claim 1, further comprising:
a memory including an artificial intelligence (AI) model trained to extract a semantic anchor spot included in an input image and characteristic information of the semantic anchor spot based on the image being input,
wherein the processor is configured to input the image acquired through the camera to the AI model to identify at least one semantic anchor spot in which an object may be positioned in the acquired image.

4. The MR providing device as claimed in claim 1, wherein
the characteristic information of the semantic anchor spot includes information on a type of an object that may be positioned in the semantic anchor spot.

5. The MR providing device as claimed in claim 4, wherein
the processor is configured to identify at least one object included in the image acquired through the camera, and identify a type of object that may be positioned in the semantic anchor spot based on the identified type of object.

6. The MR providing device as claimed in claim 5, further comprising:
a memory including an AI model trained to output a type of object that may be present additionally based on the number of objects by types being input,
wherein the processor is configured to determine a type of at least one object that may be present additionally by inputting the number of objects identified from the acquired image by types to the AI model, and
identify a type of object that may be positioned in the semantic anchor spot based on the determined type.

7. The MR providing device as claimed in claim 1, wherein
based on a plurality of semantic anchor spots being identified in the acquired image and a plurality of object regions corresponding to characteristic information of the plurality of semantic anchor spots being received from the electronic device,
the processor is configured to: select semantic anchor spots in which each of the plurality of received object regions may be positioned among the plurality of semantic anchor spots based on a distance between each of the plurality of semantic anchor spots and the MR providing device and a positional relationship between the plurality of object regions in the image frame, and control the optical display unit to display each of the plurality of received object regions on each of the semantic anchor spots.

8. The MR providing device as claimed in claim 1, wherein
based on a plurality of semantic anchor spots being identified in the acquired image,
the processor is configured to: identify a type or size of an object present in each of the plurality of semantic anchor spots in the image, select a semantic anchor spot for the received object region to be positioned among the plurality of semantic anchor spots based on the type or size of the identified object, and control the optical display unit to display the received object region in the selected semantic anchor spot.

9. The MR providing device as claimed in claim 1, wherein
the processor is configured to identify a position in which the received object region is displayed by inputting the acquired image to a generative adversarial network (GAN) trained to synthesize at least one object region in an image.

10. An electronic device comprising:
a memory configured to store a video;
a communication unit comprising communication circuitry configured to communicate with a mixed reality (MR) providing device; and
a processor connected to the memory and the communication unit,
wherein
the processor is configured to: receive characteristic information of a semantic anchor spot included in an image acquired through the MR providing device from the MR providing device through the communication unit, identify an object corresponding to the received characteristic information in an image frame included in the video, and transmit an object region including the identified object to the MR providing device through the communication unit.

11. The electronic device as claimed in claim 10, wherein
the memory includes an artificial intelligence (AI) model trained to identify a plurality of types of objects, and
the processor is configured to select one of the plurality of types corresponding to the specific information and control the AI model to identify an object of the selected type in the image frame.

12. A method of controlling a mixed reality (MR) providing device for providing real space within a preset range of viewing angle and a virtual image, the method comprising:
acquiring an image by capturing the preset range of viewing angle through a camera;
identifying at least one semantic anchor spot within the acquired image in which an object may be positioned;
transmitting characteristic information of the semantic anchor spot related to the object that may be positioned to an electronic device;
receiving an object region including the object corresponding to the characteristic information among at least one object included in an image frame of the video provided from the electronic device; and
displaying the received object region on the semantic anchor spot.

13. The method as claimed in claim 12, wherein
the camera includes a depth camera, and
in the identifying of the semantic anchor spot, depth information of a plurality of pixels of the image acquired through the camera is acquired, at least one horizontal plane in the acquired image is identified based on the acquired depth information, and
a semantic anchor spot in which an object may be positioned in the at least one identified horizontal plane based on a width of the at least one identified horizontal plane and a height thereof in a vertical direction.

14. The method as claimed in claim 12, wherein
a memory of the MR providing device includes
an artificial intelligence (AI) model trained to extract a semantic anchor spot included in the input image and characteristic information of the semantic anchor spot based on the image being input, and
in the identifying of the semantic anchor spot,
the image acquired through the camera is input to the AI model to identify at least one semantic anchor spot in which an object may be positioned in the acquired image.

15. The method of claim 12, further comprising:
identifying at least one object included in the acquired image;
determining a type of object that may be positioned in the semantic anchor spot based on the identified type of object; and
generating the characteristic information of the semantic anchor spot based on the determined type of object.
